(19) United States
(12) Patent Application Publication
(10) Pub. No.: US 2026/0334462 A1
(43) Pub. Date: Oct. 29, 2026

(54) APPARATUSES FOR SUPPORTING AN EX-VIVO ORGAN

(71) Applicant: TransMedics, Inc., Andover, MA (US)

(72) Inventors: Waleed H. HASSANEIN, North Andover, MA (US); Farhan ZAFAR, Andover, MA (US); Amira HASSANEIN, North Andover, MA (US); Mark ANDERSON, Danvers, MA (US); Brian KIMBALL, Medford, MA (US); Paul BIENIEK, Quincy, MA (US); Randy MOSHER, Methuen, MA (US); Christopher PLOTT, Marblehead, MA (US); Ruth SULLIVAN, Lawrence, MA (US); Matthew HOEY, Wakefield, MA (US); Lea WEDDLETON, East Boston, MA (US); Ashley LEVINE, Epping, NH (US)

(21) Appl. No.: 19/655,515

(22) Filed: Apr. 22, 2026

Related U.S. Application Data
(60) Provisional application No. 63/795,121, filed on Apr. 25, 2025.

(51) Int. Cl. A01N 1/143

(52) U.S. Cl. CPC A01N 1/143

(57) ABSTRACT

Disclosed herein is an organ support apparatus including a soft support surface for supporting a human organ, preferably at least one lung, and a frame containing the soft support surface. The apparatus is configured for use in an ex-vivo organ perfusion system. The soft support surface can be comprised of a flexible material, e.g., polyurethane, and include one or more drainage holes and/or drainage channels to allow perfusion fluid to drain and avoid pooling around the organ. The apparatus can be contained within a housing, which can be used with the ex-vivo organ perfusion system.

### CROSS-REFERENCE TO RELATED APPLICATIONS

This application claims priority to U.S. Provisional Application No. 63/795,121, filed Apr. 25, 2025, the entire contents of which are hereby incorporated by reference.

### FIELD OF THE INVENTION

This invention is directed to apparatuses for supporting an ex-vivo organ, especially ex-vivo lungs.

### BACKGROUND OF THE INVENTION

Lung transplantation is a primary therapy for a variety of end-stage lung diseases, such as pulmonary fibrosis, cystic fibrosis, chronic obstructive pulmonary disease, and primary pulmonary hypertension. Lung transplantation has seen significant advancements and innovation in all aspects of the surgical procedures to remove lungs from a donor and implant them in a recipient, and in the pre- and post-operative clinical management of lung transplant recipients. However, most ex-vivo donor lungs are still preserved using cold static storage. Cold storage of donor lungs for transplantation has limitations that can negatively impact utilization and outcomes, such as (1) severe time-dependent injury, which may increase the risk of primary graft dysfunction; (2) the inability to assess organ viability; and (3) the inability to modulate organ condition.

There are portable ex-vivo organ perfusion systems that address the limitations of cold storage by reducing ischemic time through use of warm, oxygenated blood-based perfusion, modulating the lung condition, and allowing for ex-vivo functional assessment. One such system is the TransMedics' Organ Care System (OCS™). There are different OCS™ systems to which different ex-vivo organs can be connected; one such system is for the lungs. Current systems for ex-vivo organ perfusion, including for the lungs, have a hard surface for supporting the ex-vivo organ. However, the hard material used in the apparatus is associated with certain drawbacks. For instance, the hard surface may lead to markings or indentations on the organ, or the appearance of bruising by the hard floor and drainage grooves of the module.

Thus, there exists a need for improved apparatuses and systems for supporting and containing an ex-vivo human organ in a perfusion system.

### SUMMARY OF THE INVENTION

The invention generally relates to systems, methods, and devices for ex-vivo organ care. More particularly, the invention relates to apparatuses for supporting an ex-vivo organ, preferably ex-vivo lungs, containing a soft support surface.

In one aspect, the invention is directed to a lung support apparatus including: a soft support surface for supporting at least one ex-vivo lung, and a frame for containing the soft support surface, wherein the apparatus is configured for use in an ex-vivo lung perfusion system. In some embodiments, the soft support surface is a soft conforming surface. In some embodiments, the soft support surface includes a flexible polymer material, e.g., polyurethane. In some embodiments, the soft support surface includes one or more drainage openings selected from drainage holes and drainage channels for draining a perfusion fluid exiting the at least one ex-vivo lung, e.g., through the left atrium. The drainage openings (e.g., the drainage holes or drainage channels) may prevent pooling of the perfusion fluid around the at least one ex-vivo lung.

In some embodiments, the frame includes a central rib. For example, the central rib supports the center of two ex-vivo lungs and promotes drainage of perfusion fluid towards a left atrial sampling port in the frame. In some embodiments, the frame includes a cut-out for a lobe of the at least one ex-vivo lung. For example, the frame includes polycarbonate.

Furthermore, in some embodiments, the soft support surface is configured to secure a flexible wrap for providing support to and anchoring the at least one ex-vivo lung. For example, the flexible wrap includes polyurethane.

The apparatus may be contained within a housing including: a bottom, walls, and an openable lid that provides a sealable connection to the walls of the housing. In some embodiments, the housing includes a gasket to provide a seal between the openable lid and the bottom of the housing. For example, the gasket may include silicone.

In another aspect, the invention includes a lung support apparatus including: (i) a soft support surface including polyurethane and having a hardness value of 90 Shore A for supporting at least one ex-vivo lung; (ii) a frame for containing the soft support surface including a central rib and a cut-out for a lobe of the at least one ex-vivo lung; and (iii) a housing for containing the soft support surface and the frame including: a bottom, walls, and an openable lid that provides a sealable connection to the walls of the housing, the openable lid including a silicone gasket to provide a seal between the openable lid and the bottom of the housing; wherein the apparatus is configured for use in an ex-vivo lung perfusion system. In some embodiments, the soft support surface includes one or more drainage openings for draining a perfusion fluid exiting the at least one ex-vivo lung, wherein the one or more drainage openings are selected from drainage holes and drainage channels. In some embodiments, the drainage openings prevent pooling of the perfusion fluid around the at least one ex-vivo lung. In some embodiments, the central rib supports the center of two ex-vivo lungs and promotes drainage of perfusion fluid towards a left atrial sampling port in the frame. In some embodiments, the frame includes polycarbonate. In some embodiments, the soft support surface is configured to secure a flexible wrap (e.g., comprising polyurethane) for providing support to and anchoring the at least one ex-vivo lung.

In another aspect, the invention includes a method of using a lung support apparatus in an ex-vivo lung perfusion system, including placing the lung support apparatus contained within a housing in the ex-vivo lung perfusion system, wherein the lung support apparatus includes: a soft support surface for supporting at least one ex-vivo lung, and a frame for containing the soft support surface. In some embodiments, the soft support surface includes a flexible polymer material, e.g., polyurethane. In some embodiments, the soft support surface includes one or more drainage openings selected from drainage holes and drainage channels for draining a perfusion fluid exiting the at least one ex-vivo lung, e.g., through the left atrium. The drainage openings (e.g., the drainage holes or drainage channels) may prevent pooling of the perfusion fluid around the at least one ex-vivo lung.

In some embodiments, the frame includes a central rib. For example, the central rib supports the center of two ex-vivo lungs and promotes drainage of perfusion fluid towards a left atrial sampling port in the frame. In some embodiments, the frame includes a cut-out for a lobe of the at least one ex-vivo lung. For example, the frame includes polycarbonate. Furthermore, in some embodiments, the soft support surface is configured to secure a flexible wrap for providing support to and anchoring the at least one ex-vivo lung. For example, the flexible wrap comprises polyurethane.

In some embodiments, the housing includes: a bottom, walls, and an openable lid that provides a sealable connection to the walls of the housing. In some embodiments, the housing includes a gasket to provide a seal between the openable lid and the bottom of the housing. For example, the gasket may include silicone.

### BRIEF DESCRIPTION OF THE DRAWINGS

The following figures depict illustrative embodiments of the invention in which like reference numerals refer to like elements. These depicted embodiments may not be drawn to scale and are to be understood as illustrative of the invention and not as limit.

FIG. 1A is a diagram of a lung support apparatus having a soft support surface.

FIG. 1B is a diagram of a housing containing a lung support apparatus having a soft support surface.

FIG. 2A is a diagram of a legacy lung support apparatus having a hard surface.

FIG. 2B is a diagram of a housing containing the legacy lung support apparatus having a hard surface of FIG. 2A.

FIG. 3A is a figure showing photos of ex-vivo lungs directly after proning when placed on a legacy lung support surface containing a hard surface or a lung support apparatus having a soft floor. The lung placed on the hard surface is on the far left (labeled L1.02.06.24), while all other lungs were placed on the soft support surface (labeled L2.07.10.24 Alpha 1, L2.07.11.24 Alpha 2, L3.07.16.24 Alpha 3, L2.07.17.24 Alpha 4, and L1.07.24.24 Alpha 5).

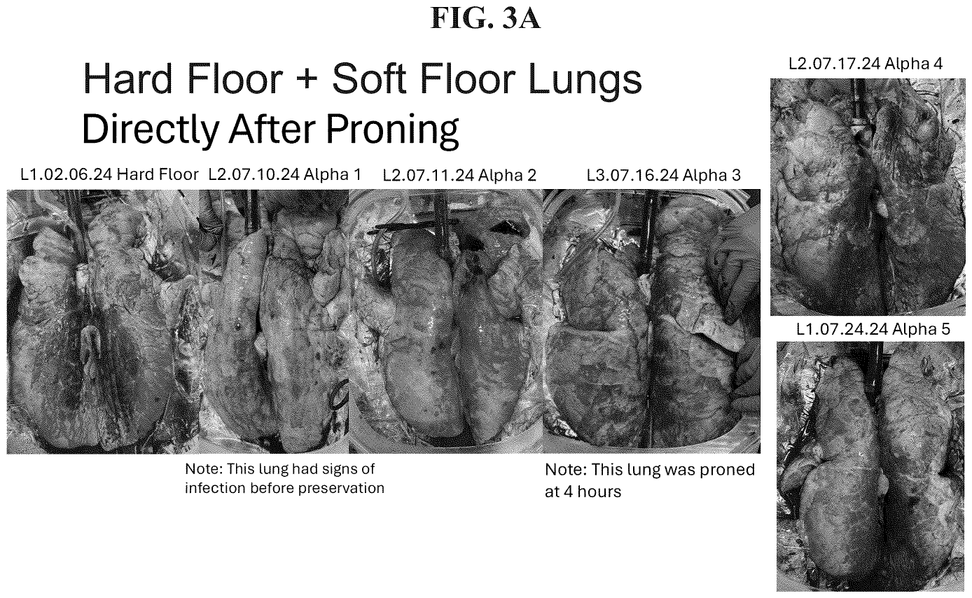

FIG. 3B is a figure showing the same lungs from FIG. 3A after 23 hours of preservation on the legacy lung support surface containing a hard surface or a lung support apparatus having a soft floor. The lung placed on the hard surface is on the far left (labeled L1.02.06.24), while all other lungs were placed on the soft support surface (labeled L2.07.10.24 Alpha 1, L2.07.11.24 Alpha 2, L3.07.16.24 Alpha 3, L2.07.17.24 Alpha 4, and L1.07.24.24 Alpha 5).

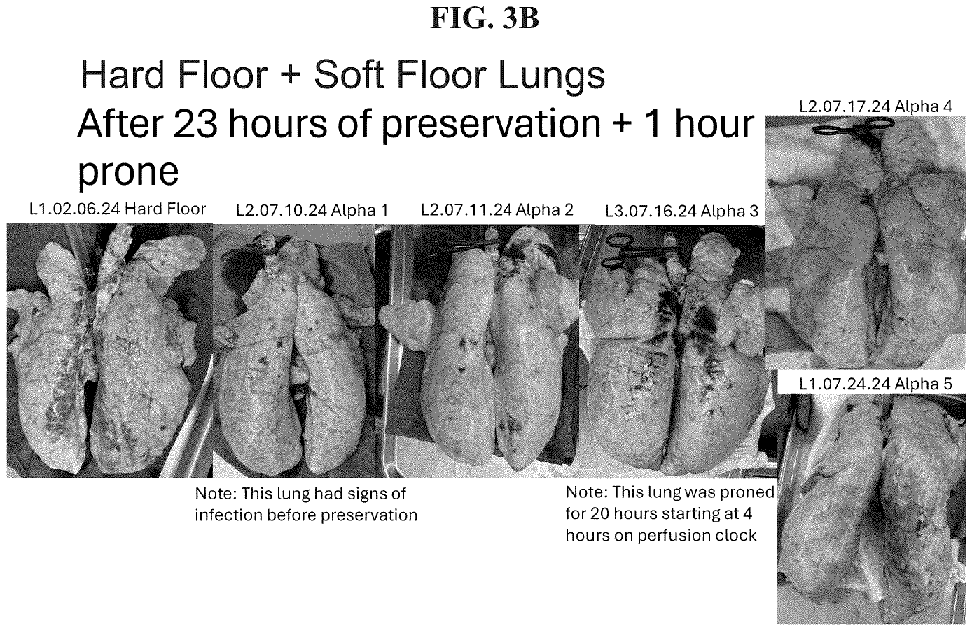

### DETAILED DESCRIPTION

The embodiments described herein provide apparatuses for supporting an ex-vivo organ. In some embodiments, the ex-vivo organ is two human lungs. The apparatuses described herein provide support to an ex-vivo organ without damaging the organ, while also allowing for perfusion fluid to drain away from the organ and providing a port to sample the perfusion fluid.

Organ Support Apparatus with Soft Support Surface

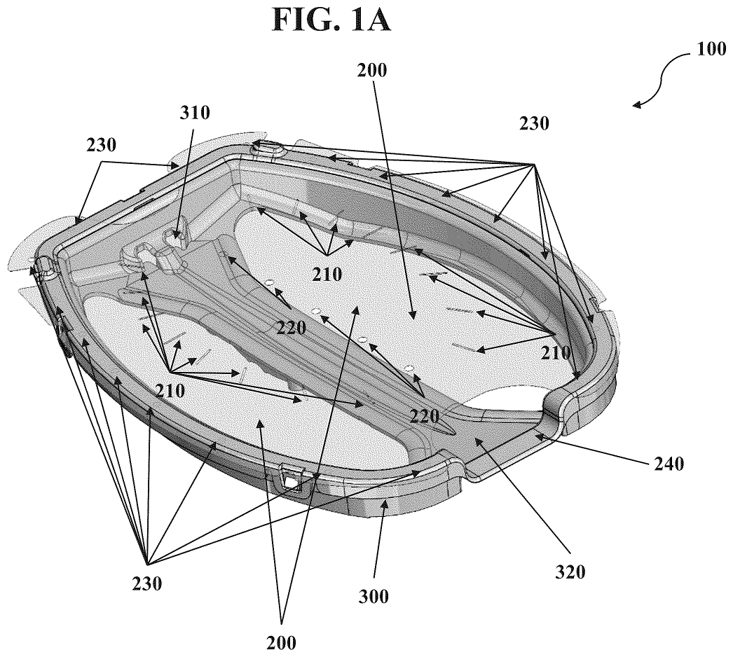

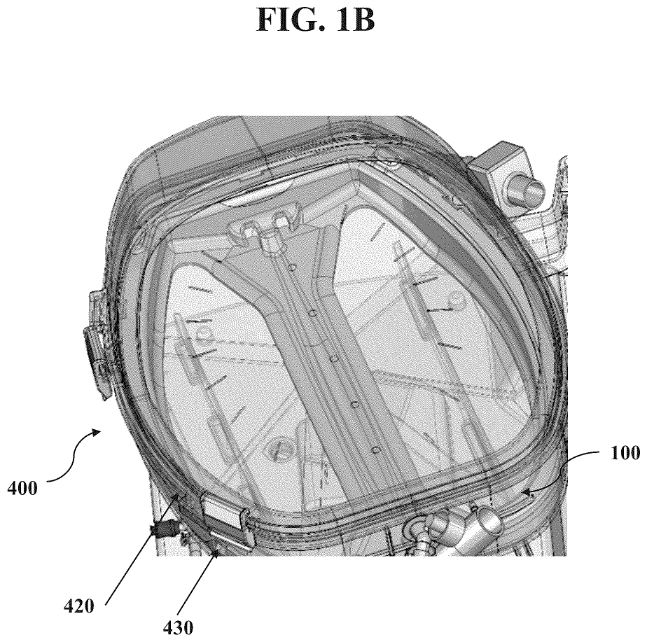

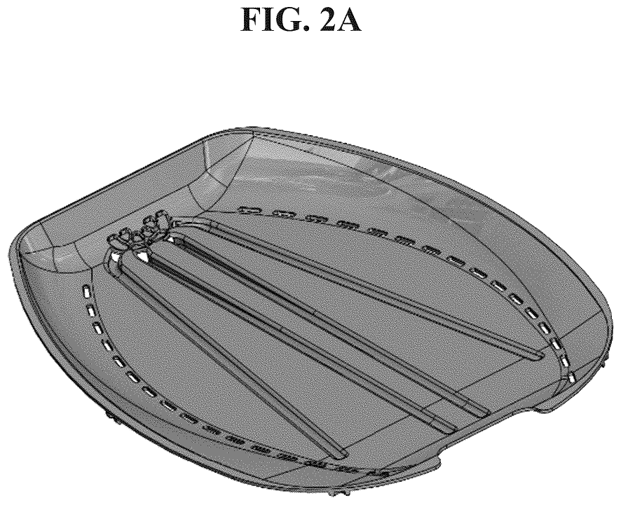

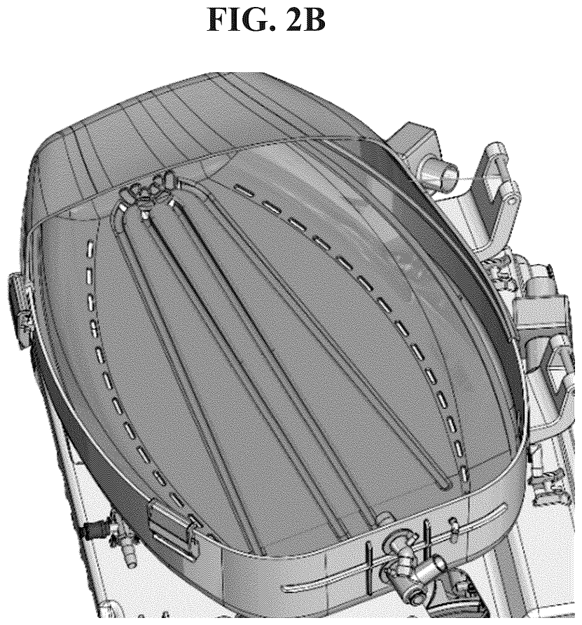

The apparatuses described herein are suitable for ex-vivo organ, preferably the lung, perfusion and include a soft surface for supporting the organ. FIG. 1A provides an exemplary embodiment of an organ support apparatus configured for the lung. As exemplified in FIG. 1A, the lung support apparatus (100) includes a soft support surface (200) set on a frame (300). The soft support surface (200) may include drainage channels (210) and/or drainage holes (220). The frame may include a central rib (320) to support the ex vivo lungs on the soft support surface. For comparison, an exemplary legacy lung support apparatus having a hard surface is depicted in FIG. 2A.

The lung support apparatus (100) and housing (400) may be configured for use in a lung perfusion module within an ex vivo lung perfusion system. For example, the lung support apparatus (100) and housing (400) may advantageously be used in a pre-existing lung perfusion module without requiring any modifications to the pre-existing lung perfusion module within the ex vivo lung perfusion system. Exemplary ex vivo lung perfusion systems include those described in, e.g., U.S. Patent Publication No. 2008/0017194 and U.S. Patent Publication No. 2009/0197325, the contents of which are hereby incorporated by reference in their entireties.

### Soft Support Surface

The soft support surface (200) comprises a material that is able to support the lungs, but is also soft enough to cushion the organ and avoid causing any damage to the lung. For example, the soft support surface (200) may be made of a biocompatible flexible polymer material. The flexible polymer material may be in the form of a thin sheet or film. The flexible polymer material may have a hardness of about 90±5 Shore A. In some embodiments, the support surface is made of polyurethane. One example of a suitable commercially available polyurethane is Dureflex® PT7500.

The soft support surface (200) may include one or more drainage openings, such as drainage channels (210) and drainage holes (220). The drainage channels (210) and holes (220) may be distributed evenly across the soft support surface (200) to provide sufficient draining across the entire surface. The soft support surface (200) may include sufficient drainage channels (210) and drainage holes (220) so that perfusion fluid can flow through the lung and away from the lung and avoid pooling of perfusion fluid around the lung. The soft support surface (200) may also include attachment holes (230) in the perimeter of the surface, which can be used to attach the soft support surface (200) to the frame (300).

### Frame

The soft lung support surface is set within a frame (300) as depicted in FIG. 1A. The soft lung support surface (200) may be attached to the frame (300) via attachment holes (230). The apparatus can include a ring (240) that spans the outer perimeter of the frame and has pegs that retain the attachment holes (230). The ring (240) then snaps onto the frame (300) to attach the soft support surface (200) to the frame (300). The frame (300) comprises a biocompatible material that is rigid enough to hold the lung on the soft support surface. For example, the frame may be made of a biocompatible polymer material. In some embodiments, the frame is made of polycarbonate. One example of a suitable commercially available polycarbonate is Makrolon® 2458.

The structure of the frame may include a central rib (320) that supports the center of the lungs when the lungs are placed on the soft support surface, as well as one or more cut-outs for the lobes of the lungs. The frame may also include an opening for a left atrial sampling port (310). As depicted in FIG. 1, the central rib (320) is designed to promote drainage of perfusion fluid towards a left atrial sampling port (310) when the lung is placed on the soft support surface (200). Providing this support and access to perfusion fluid advantageously holds the lung in place while lowering the risk of injury to the lung and allows sampling of the perfusion fluid to evaluate different aspects of the ex-vivo organ.

In some embodiments, the frame (300) is thin enough such that when it is incorporated into a lung support apparatus (100) and housing (400), the lung support apparatus (100) and housing (400) can be used with a pre-existing lung perfusion module without requiring any modifications to the module. For example, the frame (300) can be thin enough to be used with the lung perfusion modules described in U.S. Patent Publication No. 2008/0017194 and U.S. Patent Publication No. 2009/0197325.

### Lung Wrap

In some embodiments, the lungs may be wrapped when placed on the lung support apparatus (100) to provide additional support. The lungs may be wrapped with a film comprised of a flexible material, such as a biocompatible polyurethane. One example of a suitable commercially available polyurethane is Dureflex® PT7500.

The wrap can anchor the lungs, keep the lungs in a physiologic configuration, and prevent the bronchi from being kinked and limiting the total volume of lung inflation. The wrap also provides a smooth surface for the exterior of the lungs to interface with the lung support apparatus, reducing the risk of the apparatus applying excessive pressure on any part of the lungs, which might cause undesirable hemorrhaging. The polyurethane wrap may include drainage holes and drainage channels that line up with the drainage holes and channels of the soft support surface. This facilitates draining of the perfusion fluid that collects around the lungs. In some embodiments, the polyurethane wrap can be marked with a series of lines indicating how much volume is being wrapped. The desired volume of wrapped lung can be determined by an empirical relationship between lung size and the weight of the donor.

The wrap may be coupled to the soft support surface by any suitable means, including via adhesives, stitches, or anchors. Alternatively, the wrap may be coupled to the frame by any suitable means, including via adhesives, stitches, or anchors.

### Lung Housing

The lung apparatus including a soft support surface (200) and a frame (300) may be contained within a housing (400) as depicted in FIG. 1B. The housing (400) should be large enough to accommodate the support surface (200) and frame (300). The lung support apparatus (100) including the soft support surface (200) attached to the frame (300) via the ring (240) is attached to the bottom of the housing (400) with an adhesive, such as glue. For comparison, a legacy housing containing the hard surface lung support apparatus is shown in FIG. 2B.

The housing may include a bottom (430), walls (420), and an openable lid. The openable lid may provide a sealable connection to the walls (420) of the housing (400). For example, the sealable connection can be achieved by including a gasket to provide a seal between the openable lid and the walls (420). The gasket may be made of any suitable biocompatible material for providing a seal. For example, the gasket may be made of silicone. One example of a suitable commercially available silicone is GE LIM6030 silicone. Beneficially, the gasket provides a tight enough seal between the openable lid and the walls (420) of the housing (400) such that the apparatus does not need to be covered with a sterile cover or banded bag to protect the apparatus from external environmental contamination during transportation.

The housing (400) comprises a biocompatible material rigid enough to hold the support surface and frame of the lung support apparatus. For example, the housing (400) may be made of polycarbonate. One example of a suitable commercially available polycarbonate is Makrolon® 2458.

There are various advantages associated with using a soft surface to support an ex-vivo organ, preferably ex-vivo lungs, as described herein. A lung is a delicate organ, and perfusing a lung in a legacy apparatus containing a hard floor could lead to organ markings, indentations, or the appearance of bruising by the hard floor and drainage grooves on the organ. Including a soft floor for a support surface mitigates these downsides and reduces damage to the lung, while effectively supporting the lung during perfusion and preventing pooling of perfusion fluid around the lung. The soft support allows homogenous ventilation and breathing movement of the back of the lungs. The soft support surface can also interface with a frame that allows perfusion fluid to be sampled from particular parts of the ex-vivo organ to evaluate organ functionality. The soft support surface and frame can also advantageously be used with pre-existing lung perfusion modules, such as described in U.S. Patent Publication No. 2008/0017194 and U.S. Patent Publication No. 2009/0197325, without requiring any modifications be made to the pre-existing modules.

### EXAMPLES

The following non-limiting examples are provided to illustrate the present disclosure.

### Example 1

Five tests were performed using porcine lungs and a prototype design of a lung perfusion module including a soft support surface, according to an embodiment described herein. The study also included one hard floor control. The soft support surface lung perfusion module was used to replace the hard floor lung module within TransMedics' OCS™ Lung. Testing was performed for 24 hours under normal clinical conditions and with lungs in the supine position (similar to if a patient were to lay on their back), with at least the final 1 hour in the proned position (similar to if a patient were to lay on their face, i.e., with the anterior surface of the lung face down towards the support surface). Normal clinical conditions mimic physiological flow and pressures. These conditions include a mean pulmonary artery pressure (PAP) of <20 mm Hg; normal volume controlled ventilation with a peak airway pressure of 25 cm H₂O; and peak end expiratory pressure (PEEP) maintained throughout preservation (i.e., not <5 cm H₂O).

Images taken during the study of the five soft floor test lungs and the hard floor control lung are provided in FIGS. 5A and 5B. The images in FIG. 5A show the lungs directly after proning, while the images in FIG. 5 a show the lungs at the end of the study. In FIGS. 5A and 5B, the lung placed on the hard surface is on the far left (labeled L1.02.06.24), while all other lungs were placed on the soft floor (labeled L2.07.10.24 Alpha 1, L2.07.11.24 Alpha 2, L3.07.16.24 Alpha 3, L2.07.17.24 Alpha 4, and L1.07.24.24 Alpha 5). Clinical observations for the lungs placed on the soft floor are provided in Table 1 below.

All five sets of lungs were successfully perfused on the soft support surface for the 24-hour duration of the study. Visual observations of each of the lungs indicated the soft floor prevented the appearance of indentations previously caused by the organ chamber hard floor.

TABLE 1
Clinical Observations for Soft Supported Lungs

| | Alpha | Clinical Observations | Clinical Observations Post |
|---|---|---|---|
| Animal ID | Number | Before Instrumentation | Preservation |
| L2.07.10.24 | 1 | Consolidation vs. | Few small areas of darkened tissue on |
| | | atelectasis in left and | posterior, lungs feel heavy, anterior |
| | | right upper lobes | segments not perfused, edema |
| L2.07.11.24 | 2 | No clinical observations | Some normal congestion, some small |
| | | | surface marks on posterior, not enough |
| | | | for clinical relevance |
| L3.07.16.24 | 3 | Atelectasis bilaterally at | Lots of darkened areas on posterior and |
| | | lower lobes | anterior of lungs |
| L2.07.17.24 | 4 | Lungs mildly deflated, | None, good lungs |
| | | atelectasis on all lobes | |
| L1.07.24.24 | 5 | Atelectasis on both lower | Right upper lobes under PA, out of wrap |
| | | lobes | so dried out. Intact on interior, |
| | | | hypoperfusion on anterior right surface. |
| | | | Areas of consolidation, bad lungs to |
| | | | begin with. No impressions on posterior. |

### Example 2

Testing was conducted to confirm that the frame of the modified chamber bottom does not negatively affect device performance when an embodiment of the lung support apparatus as described herein is used in an ex vivo lung perfusion system.

An OCS™ Lung Perfusion module modified to include an embodiment of the lung support apparatus as described herein including the soft support surface. The lung support apparatus was sterilized with ethylene oxide (EtO) and installed on the OCS™ Lung Console and was controlled by a production-equivalent software version. The perfusion module was filled with 2.0±0.1 L of fluid and the system was set to Preservation Mode and run at 1.0±0.1 L/min at 37 °C. The perfusate flow rate through the sampling line of the apparatus was measured as a verification test. Table 2 outlines the testing steps and expected results for this study.

The system met the expected results for each test method in Table 2. The OCS™ Lung System drain was properly connected to the sampling port and saturation cuvette and drained as expected. The redesigned floor including the soft support surface and frame in the chamber bottom does not negatively impact drain performance.

TABLE 2
Drain and Pool Test

| Test Method | Expected Result | Pass/Fail |
|---|---|---|
| Visually verify the presence of a secondary | LA perfusate drain present. | Pass |
| drain in the organ chamber that collects left | | |
| atrial perfusate. | | |
| Visually verify the LA perfusate drain flows | LA perfusate drain | Pass |
| directly to a sampling port and a cuvette for | connects to sampling port | |
| measuring oxygen saturation | and O₂ saturation cuvette. | |
| Using a ¼″ flow probe on an OCS ™ Heart | LA drain line flow | Pass |
| or Liver Console, measure the LA drain line | of ≥200 mL/min at pump | |
| flow at 1 ± 0.1 and 3 ± 0.1 LPM pump flow. | flows of 1 and 3 LPM. | |
| With the system set to a pump flow of 4 ± | No vortex formation. | Pass |
| 0.1 LPM, attempt to induce a vortex in the | | |
| organ chamber using the ½″ length of | | |
| tubing connected to the PA port to direct the | | |
| fluid stream in a circular motion. Verify | | |
| that a vortex cannot be formed. | | |
| Verify that the primary drain empties the | No back-up in organ | Pass |
| chamber without back-up at 4 ± 0.1 LPM. | chamber. | |

### Example 3

An embodiment of the lung support apparatus described herein was also tested to determine whether the housing provides an adequate barrier to outside contamination without the use of banded bags or a sterile cover.

Six sterile apparatuses including the soft support surface contained within the housing were tested (3 test and 3 negative control). Sterile balloon Breather Bags were placed inside the apparatuses and were used to simulate the air exchange factors of a breathing lung inside of an organ chamber. Test and control apparatuses were seeded with 8 open petri dishes containing filter membranes; the dishes were placed under and around the balloon on the lung wrap. The housings were then closed and latched.

The test and control apparatuses were placed inside TransMedics' OCS™ Lung Console and were ventilated in Preservation Mode for 6 hours, including transport in an automobile for at least 60 minutes. Then the filter media were removed, placed in TSA plates and incubated. At the end of the incubation period, all plates were visually examined for the presence of microbial growth. Testing for growth on the inside of the chamber lid was also conducted according to the same method and using contact agar plates.

The acceptance criteria were that there was to be no growth observed on the filter media retrieved from inside the organ chambers of the apparatuses or on the plated samples taken from the inside surfaces of the apparatuses' chamber lids.

Results from the testing show that no growth was observed in all filter media retrieved from inside the organ chambers for all tests and negative controls. No growth was observed on the plates from inside of the chamber lids for all tests and negative controls.

What is claimed is:

1. A lung support apparatus comprising:
a soft support surface for supporting at least one ex-vivo lung, and
a frame for containing the soft support surface,
wherein the apparatus is configured for use in an ex-vivo lung perfusion system.

2. The apparatus of claim 1, wherein the soft support surface comprises a flexible polymer material.

3. The apparatus of claim 1, wherein the soft support surface is comprised of polyurethane.

4. The apparatus of claim 1, wherein the soft support surface comprises one or more drainage openings for draining a perfusion fluid exiting the at least one ex-vivo lung, wherein the one or more drainage openings are selected from drainage holes and drainage channels.

5. The apparatus of claim 4, wherein the drainage openings prevent pooling of the perfusion fluid around the at least one ex-vivo lung.

6. The apparatus of claim 1, wherein the frame comprises a central rib.

7. The apparatus of claim 6, wherein the central rib supports the center of two ex-vivo lungs and promotes drainage of perfusion fluid towards a left atrial sampling port in the frame.

8. The apparatus of claim 1, wherein the frame comprises a cut-out for a lobe of the at least one ex-vivo lung.

9. The apparatus of claim 1, wherein the frame comprises polycarbonate.

10. The apparatus of claim 1, wherein the soft support surface is configured to secure a flexible wrap for providing support to and anchoring the at least one ex-vivo lung.

11. The apparatus of claim 1, wherein the flexible wrap comprises polyurethane.

12. The apparatus of claim 1, wherein the apparatus is contained within a housing comprising:
a bottom,
walls, and
an openable lid that provides a sealable connection to the walls of the housing.

13. The apparatus of claim 12, wherein the housing comprises a gasket to provide a seal between the openable lid and the bottom of the housing.

14. The apparatus of claim 13, wherein the gasket comprises silicone.

15. A lung support apparatus comprising:
a soft support surface comprising polyurethane and having a hardness value of 90 Shore A for supporting at least one ex-vivo lung;
a frame for containing the soft support surface comprising a central rib and a cut-out for a lobe of the at least one ex-vivo lung; and
a housing for containing the soft support surface and the frame comprising:
a bottom,
walls, and
an openable lid that provides a sealable connection to the walls of the housing, the openable lid comprising a silicone gasket to provide a seal between the openable lid and the bottom of the housing;
wherein the apparatus is configured for use in an ex-vivo lung perfusion system.

16. The apparatus of claim 15, wherein the soft support surface comprises one or more drainage openings for draining a perfusion fluid exiting the at least one ex-vivo lung, wherein the one or more drainage openings are selected from drainage holes and drainage channels.

17. The apparatus of claim 16, wherein the drainage openings prevent pooling of the perfusion fluid around the at least one ex-vivo lung.

18. The apparatus of claim 15, wherein the central rib supports the center of two ex-vivo lungs and promotes drainage of perfusion fluid towards a left atrial sampling port in the frame.

19. The apparatus of claim 15, wherein the frame comprises polycarbonate.

20. The apparatus of claim 15, wherein the soft support surface is configured to secure a flexible wrap for providing support to and anchoring the at least one ex-vivo lung.

21. The apparatus of claim 15, wherein the flexible wrap comprises polyurethane.

22. A method of using a lung support apparatus in an ex-vivo lung perfusion system, comprising placing the lung support apparatus contained within a housing in the ex-vivo lung perfusion system, wherein the lung support apparatus comprises:
a soft support surface for supporting at least one ex-vivo lung, and
a frame for containing the soft support surface.

23. The method of claim 22, wherein the soft support surface comprises a flexible polymer material.

24. The method of claim 22, wherein the soft support surface is comprised of polyurethane.

25. The method of claim 22, wherein the soft support surface comprises one or more drainage openings for draining a perfusion fluid exiting the at least one ex-vivo lung, wherein the one or more drainage openings are selected from drainage holes and drainage channels.

26. The method of claim 25, wherein the drainage openings prevent pooling of the perfusion fluid around the at least one ex-vivo lung.

27. The method of claim 22, wherein the frame comprises a central rib.

28. The method of claim 27, wherein the central rib supports the center of two ex-vivo lungs and promotes drainage of perfusion fluid towards a left atrial sampling port in the frame.

29. The method of claim 22, wherein the frame comprises a cut-out for a lobe of the at least one ex-vivo lung.

30. The method of claim 22, wherein the frame comprises polycarbonate.

31. The method of claim 22, wherein the soft support surface is configured to secure a flexible wrap for providing support to and anchoring the at least one ex-vivo lung.

32. The method of claim 31, wherein the flexible wrap comprises polyurethane.

33. The method of claim 22, wherein the housing comprises:
a bottom,
walls, and
an openable lid that provides a sealable connection to the walls of the housing.

34. The method of claim 33, wherein the housing comprises a gasket to provide a seal between the openable lid and the bottom of the housing.

35. The method of claim 34, wherein the gasket comprises silicone.
